(19) United States
(12) Patent Application Publication
(10) Pub. No.: US 2010/0296986 A1
(43) Pub. Date: Nov. 25, 2010

(54) Microscreen for filtering particles in microfluidics applications and production thereof

(76) Inventor: Ando Feyh, Tamm (DE)

Correspondence Address: KENYON & KENYON LLP, ONE BROADWAY, NEW YORK, NY, 10004, US

(21) Appl. No.: 12/308,303

(22) PCT Filed: Jul. 13, 2007
(86) PCT No.: PCT/EP2007/057275

§ 371 Date: Aug. 2, 2010

(30) Foreign Application Priority Data
Sep. 4, 2006 (DE) 10 2006 041 396.2

(51) Int. Cl. B01D 39/10; C23F 1/00; C25F 3/00

(52) U.S. Cl. 422/534; 216/2; 205/640

(57) ABSTRACT

A microscreen and its production method for filtering particles in microfluidics applications. The microscreen includes an at least regionally p-doped Si substrate having a recess, a macroporous membrane connected to the Si substrate via n-doped regions, the recess of the Si substrate being situated directly under the membrane to form a cavity.

### FIELD OF THE INVENTION

The present invention relates to a microscreen for filtering particles in microfluidics applications and the production thereof.

### BACKGROUND INFORMATION

Many microstructured components have been proposed for applications in microfluidics. In addition to micropumps and microvalves, microscreens for filtering particles have also been described. Thus, a microfilter is discussed in US 2005/0092676 which is made up of an isolating layer and a substrate supporting it. Both layers may be porous, in this context, an inorganic material such as silicon or an organic material such as a polymer being proposed for the filter diaphragm. While the actual isolating layer is mounted on the top side of the substrate as filter diaphragm, the back surface of the substrate is open.

Such filters that are open in the downward direction are not able to be readily integrated into appropriate microfluidics systems, as, for instance, in the “lab on chip” approach.

On the other hand, diaphragms of porous silicon are known, having a cavity situated below them, which are provided for sensor components. German patent document DE 100 46 622 A1, for example, discusses a diaphragm sensor unit, having a substrate, in which the thermal elements are situated on a silicon diaphragm. The diaphragm has nanoporous or mesoporous areas, in this instance. Furthermore, an isolating well for thermal isolation is provided under the diaphragm, the isolating well also being able to be developed as a cavity.

One may implement buried microchannels under a nanoporous or mesoporous diaphragm. Their production by a two-step electrochemical process is discussed, for instance, in the work “Planar CMOS Compatible Process for the Fabrication of Buried Microchannels in Silicon, Using Porous-Silicon Technology”, G. Kaltsas et al., J. MEMS, Vol. 12, No. 6, 2003, 863-872. In this context, the individual processes “Formation of Porous Silicon” and “Electropolishing” were carried out one after the other. The pore diameters in the diaphragm were in the range of a few nm.

In a similar way, microchannels were produced under a mesoporous diaphragm in the work, “Multi-Walled Microchannels: Free-Standing Porous Silicon Membranes for Use in μTAS”, R. Tjerkstra et al., J. MEMS, Vol. 9, No. 4, 2000, 495-501. According to the work cited, the pore diameters in the diaphragm had a maximum of 14 nm.

However, such nanoporous or mesoporous diaphragms that were discussed are not suitable, or only conditionally suitable as mechanical particle filters in microfluidic systems. Pores having average pore diameters of 2-5 nm are generally understood to be nanopores. By contrast, mesopores have average pore diameters of up to 50 nm. Pores having average pore diameters greater than 50 nm are designated as macropores. These designations also apply in the present document.

Nanoporous or mesoporous diaphragms up to now, that have small pore diameters of typically less than 2-5 or 14 nm tend rapidly to clogging or damage. However, simple electropolishing under a macroporous Si layer, to form a cavity under a macroporous diaphragm, is not readily possible.

In the case of nanoporous or mesoporous silicon, the electrical resistance of the Si structure (the skeleton structure) of the porous microstructure is relatively high, so that this structure is not attacked during a subsequent electropolishing step. The diaphragm therefore remains intact. In the case of macroporous silicon, however, the electrical resistance is less. For this reason, an attack on the porous silicon microstructure may occur during electropolishing, and the actual diaphragm is destroyed. Thus, mechanical stability is not ensured.

It is an object of the exemplary embodiments and/or exemplary methods of the present invention to provide a microfilter, and a method for its production, that is suitable for applications in microfluidics, especially for integration into microfluidic systems. This object is attained by the features described herein.

### SUMMARY OF THE INVENTION

The subject matter having the features described herein has the advantage over the microfilters up to now, that it has features that are optimized for applications in microfluidic systems, such as relatively large pore diameters, greater than 50 nm, which may be in the μm range, particularly in the 1-5 μm range, in a diaphragm. Thus, the diaphragm having the macropores may be used, with a cavity situated below it, as a preconnected particle filter in sensitive fluidics systems.

Additional refinements of the exemplary embodiments and/or exemplary methods of the present invention are also described herein in the specification.

Exemplary embodiments of the present invention are illustrated in the drawings and are subsequently explained in greater detail.

### BRIEF DESCRIPTION OF THE DRAWING

FIG. 1a and FIG. 1b shows a first exemplary embodiment for a production method of a microscreen.

FIGS. 2a and FIG. 2b show a further exemplary embodiment for a production method of a microscreen in a side view.

### DETAILED DESCRIPTION

For the production of a microscreen, for filtering particles in microfluidic system applications, a method is proposed using a two-step etching process, having a first and a second etching process:
a) providing a silicon substrate that is p-doped at least region by region,
b) forming at least region by region a layer of n-doped areas on the Si substrate,
c) producing a macroporous layer on the Si substrate by a first etching process, and
(d) converting the macroporous layer into a self-supporting diaphragm, using a second etching process that is different from the first etching process, by generating a cavity under the macroporous layer, the second etching process being electropolishing.

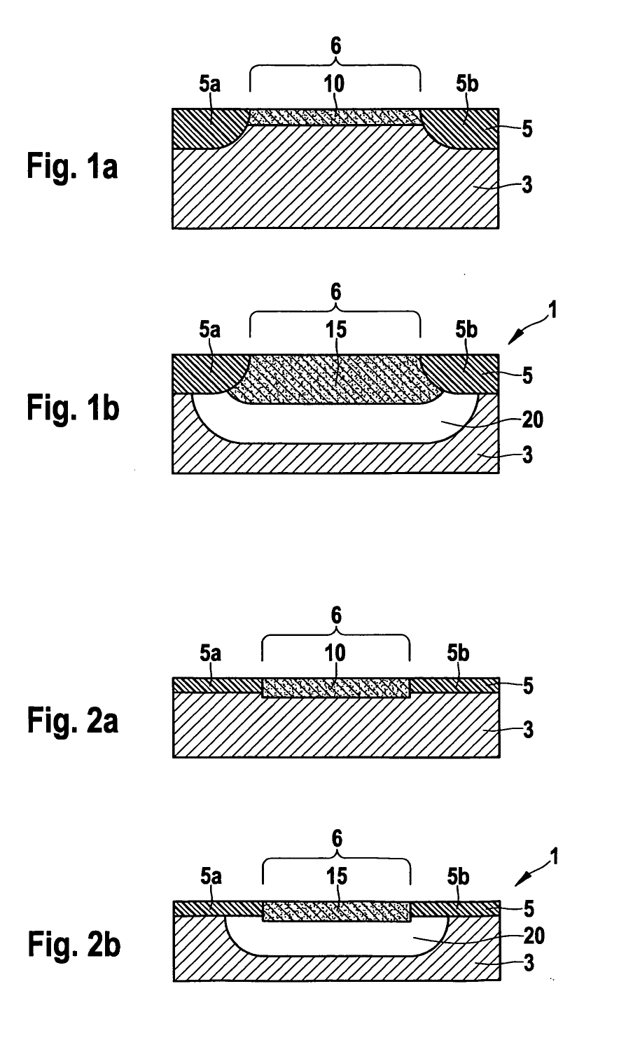

The fundamental method will now be explained using a first exemplary embodiment and FIGS. 1a and 1b. An Si substrate 3 that is p-doped at least from region to region according to step a) is first made available. The substrate material may have a specific resistance of ρ≧1 Ωcm.

In a next step b) a layer 5 made of n-doped regions 5a, 5b is formed from region to region on Si substrate 3. In this case, layer 5 is a mask, or, more accurately, an n-depth mask, and is situated about the later membrane area. One possibility of forming n-doped regions 5a, 5b is an implantation process. The implantation zone achieved thereby behaves inertly in the further process steps, and is used for suspending the later membrance.

Moreover, in a step c), a macroporous layer 10 is produced on Si substrate 3 by a first etching process, in this case, electrochemical etching in a hydrofluoric acid-containing (HF) electrolyte being provided. As may be seen in FIG. 1a, macroporous layer 10 is produced in a region not protected by the mask, the later filtering region 6, in this instance. The final thickness of macroporous layer 10 has not yet been reached in FIG. 1a, that is, the illustration in FIG. 1a is a snap shot during the first etching process.

Before the actual production of macroporous layer 10 by etching methods such as wet-chemical etching in potassium hydroxide solution (KOH) or reactive ion etching (RIE), etching nuclei, especially small depressions, are produced for the prepatterning of the macropores to be generated. The etching nuclei, as nucleation nuclei, in this instance support the pores in taking up the desired orientation and assuming the desired packing density. By this prepatterning, one is also able to influence the later filtering grade, i.e. the average pore diameter. In addition, one is able to set the average pore diameter, and also the later average wall thickness, depending on the selection or strength of the substrate doping.

As was mentioned above, macroporous layer 10 itself is then produced using electrochemical etching in a hydrofluoric acid-containing (HF) electrolyte. As wetting agent, which may be an organic solvent is used in this instance. This organic additive permits the setting of the HF concentration, as well as the targeted development of the macropores in p-doped silicon substrate 3. Suitable solvents are, for example, dimethylformamide (DMF), dimethylsulfoxide (DMSO) or acetonitrile (MeCN). The development of the macropores takes place at the previously provided nucleation nuclei. Incidentally, an HF concentration in a range from 1 to 20 wt. % may be used.

The final thickness of macroporous layer 10, which is converted into a self-supporting membrane 15 in step d), may be in a range of 10 to 50 μm. The conversion of macroporous layer 10 into a self-supporting membrane 15 is achieved by producing a cavity 20 under layer 10. In this context, cavity 20 is produced by an additional etching step, namely by electropolishing. This etching step may advantageously be carried out in the same etching medium as is used for producing macroporous layer 10, by a targeted increase in the electric current density. But alternatively it is also possible to perform the electropolishing in an etching medium that is especially adapted to the electropolishing. For this one may use mixtures of higher concentration HF, alcohol and H₂O, and which may be done using an HF concentration about 20 wt. % or greater. This permits one to achieve etching rates of more than 200 nm/s. Using the duration of the etching, one is able to set in a wide range the depth of hollow space 20, that is, the depth of the cavity. This makes possible hollow spaces 20, or rather cavities, having a depth of a few μm up to more than 100 μm.

Since etching by electropolishing is an isotropic process, it has to be prevented by a suitable measure that membrane 15 is simply dissolved out from substrate 3, in this etching step. Such a suitable measure is represented by the inert n-doped mask, as was formed in step b).

Another exemplary embodiment is explained with the aid of FIGS. 2a and 2b. Starting from step a) that has already been explained, in step b) again a layer 5 of n-doped regions 5a, 5b is formed on Si substrate 3, in contrast to the first exemplary embodiment, n-doped regions 5a, 5b now being first of all applied onto Si substrate 3, over the entire surface. This intermediate case is not represented in the figures. In order to convert substrate 3 into the state shown in FIG. 2a, that is, in order to produce a macroporous layer 10 in a step c), regionally, in the uppermost layer plane by a first etching process, a dry etching method is used. In this context, trench openings are defined using an additional mask, that is not drawn in in the figures, typically a resist mask. Trench patterns, which run over the entire thickness of layer 10, are implemented via the trench openings. In this trench process, the openings are etched at least until they reach into substrate 3. These openings, which in this document are also understood to mean pores, and which are essential for the later filtering function, are defined solely by the trench patterning. Using this procedure, any desired filter geometries are possible, since trenched n-doped filter region 6 is not attacked by the electropolishing that is now to take place. The geometric embodiment of the openings, such as, for example, the width of the openings or their distribution in macroporous layer 10 may thus be controlled in a checked manner. This procedure is particularly suitable for producing a very thin screen.

Subsequently, in a step d), a cavity 20 is generated under macroporous layer 10 using electropolishing, as is known from the first exemplary embodiment.

In all the exemplary embodiments, depending on requirements, it is meaningful and possible, after its production, to provide membrane 15 with a functional layer not shown in the figures, in addition to steps a) through d). Moreover, membrane 15 may be rendered hydrophilic by slight oxidation. As a functional layer, a reactive layer or a layer having catalytic properties may also be used. The screen will then be used as a microreactor, in addition to its filter function. For this purpose, the functional layer may be made, for instance, of platinum, palladium or nanocrystalline iron.

In the case of the use of nanocrystalline iron as the functional layer, there are interesting possibilities of applications in the field of neutralizing environmental poisons. It has been reported that such nanoparticles act in a neutralizing manner on heavy metals, dioxin, PCB and a plurality of additional poisonous substances. As a result, such poisons may be neutralized both in the input area of a lab-on-chip system and perhaps also poisonous reaction products created during the analysis.

We note that a microscreen 1 is produced, by the method explained, for application in microfluidic systems, the finished microscreen including:
a Si substrate 3 that is p-doped at least regionally, having a recess,
a macroporous membrane 15 connected to Si substrate 3 via n-doped regions 5a, 5b,
the recess of Si substrate 3 being situated directly under membrane 15 to form a cavity 20.

Macroporous membrane 15 may have pores or openings, in this instance, having a diameter from 1 to 5 μm. In one particular specific embodiment, macroporous membrane 15 is able to have trench structures which run over the entire thickness of Membrane 15. It is also possible that membrane 15 is provided with a functional layer, especially a reactive layer and/or a catalytically acting layer. Platinum, palladium or nanocrystalline iron, for example, are suitable as the material of the functional layer.

The production of microscreen 1 includes a two-step etching method, the first etching process not being electropolishing and creating a macroporous layer 10 on Si substrate 3, while the second etching process is electropolishing and forms a recess under macroporous layer 10.

The application of above-described microscreen 1 in microfluidic systems, such as in lab-on-chip systems, is made possible particularly when test samples are to be tested directly and without previous preparation. Consequently, the use of microscreen 1 is suitable for samples particularly from (bio-)chemical, medicinal and clinical fields.

1-10. (canceled)

11. A microscreen for filtering particles in microfluidic system applications, comprising:
an at least regionally p-doped Si substrate having a recess; and
a macroporous membrane connected to the Si substrate via n-doped regions;
wherein the recess of the Si substrate is situated directly under the membrane to form a cavity.

12. The microscreen of claim 11, wherein the macroporous membrane has pores having a diameter of 1 to 5 μm.

13. The microscreen of claim 11, wherein the macroporous membrane has trench patterns which run over an entire thickness of the membrane.

14. The microscreen of claim 11, wherein the membrane is provided with a functional layer, which includes at least one of a reactive layer and a catalytically acting layer.

15. The microscreen of claim 14, wherein the functional layer is made of one of platinum, palladium and nanocrystalline iron.

16. A method for producing a microscreen for microfluidic systems using a two-step etching procedure having a first etching process and a second etching process, the method comprising:
a) providing a Si substrate that is p-doped at least regionally;
b) at least regionally forming a layer of n-doped regions on the Si substrate;
c) producing a macroporous layer on the Si substrate by a first etching process; and
d) converting the macroporous layer into a self-supporting membrane, using a second etching process that is different from the first etching process, by generating a cavity under the macroporous layer, the second etching process including electropolishing.

17. The method of claim 16, wherein, between the forming of b) and the producing of c), additional etching methods, which include one of wet-chemical etching in (KOH) and reactive ion etching (RIE), are used, and etching nuclei, which include small depressions, are provided for prepatterning the macropores to be generated, before the macroporous layer is actually produced.

18. The method of claim 16, wherein, in the forming of b), the layer is formed only regionally on the Si substrate from n-doped regions for producing a mask, and in the producing of c), the macroporous layer is produced using electrochemical etching in a fluoric acid-containing electrolyte, an organic solvent, which includes at least one of dimethylformamide (DMF), dimethylsulfoxide (DMSO) and acetonitrile (MeCN), is used as a wetting agent.

19. The method of claim 16, wherein in the forming of b), the layer is formed continually on the Si substrate from n-doped regions, and subsequently, a mask made of resist, for instance, is applied, and in the producing of c), the macroporous layer is produced using dry etching, and wherein trench patterns, which run over the entire thickness of layer (10), are implemented.

20. The method of claim 16, wherein the membrane is provided with a functional layer that is made of one of platinum, palladium and nanocrystalline iron, in addition to the operations of a) through d).
